(19) United States
(12) Patent Application Publication
(10) Pub. No.: US 2003/0231551 A1
(43) Pub. Date: Dec. 18, 2003

(54) Health watch

(76) Inventors: Rose L. Saylor, Coldiron, KY (US); Dorothy Long, Evarts, KY (US)

Correspondence Address: Richard C. Litman, LITMAN LAW OFFICES, LTD., P.O. Box 15035, Arlington, VA, 22215, US

(21) Appl. No.: 10/094,278

(22) Filed: Jun. 14, 2002

(51) Int. Cl. G04B 47/00

(52) U.S. Cl. 368/10

(57) ABSTRACT

A health indicating watch capable of measuring and displaying by digital readout the user's body temperature, pulse, and blood pressure. The watch can show the time of day, beep when a monitoring function is complete, has an illumination unit for lighting the display, records information, has a printout capability, and can download functions to an external computer. The watch is solar powered and provides a page when a caller wishes to communicate with the wearer of the health watch.

### BACKGROUND OF THE INVENTION

1. Field of the Invention

The present invention relates generally to wristwatches. More specifically, the invention is a wristwatch capable of measuring and displaying by digital readout the user's body temperature, pulse, and blood pressure. The watch can show the time of day, illuminate, beep when a monitoring function is complete, record information, and has a printout capability and download functions to an external computer. The watch is solar powered and can perform paging functions.

2. Description of the Related Art

The related art of interest describes various watches to monitor and display certain values, but none discloses the present invention. There is a need for a solar powered multifunction health indicating wristwatch which can digitally measure and display body temperature, pulse, blood pressure, time of day, time intervals, is illuminated, records certain information, prints out information, and pages when a calls are received. The related art will be discussed according to the perceived relevance to the present invention.

U.S. Pat. No. 5,734,625 issued on Mar. 31, 1998, and a divisional U.S. Pat. No. 5,894,454 issued on Apr. 13, 1999, to Yutaka Kondo describes a wristwatch device with liquid crystal panels capable of measuring body pulse rate, time of day or elapsed time, acceleration, body temperature, atmospheric pressure, humidity, intensity of ultraviolet radiation, wind speed, and ambient temperature along with electric circuitry and magnets in a separate but attached external unit for measuring these parameters. An external fingertip device or attachment to an arm is utilized. The power supply is not disclosed. The disclosure of the '625 and '454 patents is hereby incorporated by reference. The device is distinguishable for lacking a pager, a solar power supply, illumination, and a printer capability.

U.S. Pat. No. 5,848,027 issued on Dec. 8, 1998, to James E. Dotter describes a system for recording physical activity by a digital timepiece worn on the wrist by an athlete for subsequent playback via an audible transmission link to a digital computer for processing, analysis and display. The wristwatch contains a microprocessor for providing the clock count, a random access memory, and a piezoelectric element for producing tone output or beeps. Data such as date and time of workout, lap time, finish times, and progressive heart rate are recorded. The system is distinguishable for lacking illumination, a pager, solar powering, and printout capability. The disclosure of the '027 patent is hereby incorporated by reference.

U.S. Pat. No. 3,937,004 issued on Feb. 10, 1976, to Minoru Natori et al. describes a pager wristwatch comprising a speaker for emitting an alarm at a preset time, reproduction of an external call signal intercepted by a receiver for incoming electromagnetic waves, an electro-optical display, and an unnamed power supply. The device has sensors responsive to abnormal ambient conditions such as temperature and blood pressure, and to operate the speaker. The device is distinguishable for lacking illumination, a solar power source, and a printer.

U.S. Pat. No. 4,525,075 issued on Jun. 25, 1985, to Kazunori Kita describes an electronic wristwatch having a time display, a handwriting input portion, and a printer inside with a recording paper loading and printing portion. The printing head is moved by an operation member, and a displacement thereof is detected by an operation member. A print control circuit controls the printing of the printing head in accordance with a speed corresponding to the displacement detected by the detecting portion. The disclosure of the Kita patent is hereby incorporated by reference, but the device is distinguishable for lacking a pager, solar powering, and measuring functions of pulse, body temperature, and blood pressure.

U.S. Pat. No. 5,481,506 issued on Jan. 2, 1996, to Kazumori Kita describes a wristwatch comprising multiple sensor units utilized separately for displaying time, temperature, barometric pressure, and pulse rate. The device is distinguishable for its requirement for separate sensor units.

U.S. Pat. No. 4,151,831 issued on May 1, 1979, to Robert W. Lester describes a fertility indicator device worn as a neck pendant for measuring and detecting the body temperature over a menstrual cycle, the device having a timer for generating time based signals, and a logic circuit connected to the clock timer responsive to the time based signals for selecting the proper combinations of the time based signals and for indicating the present time. A temperature sensor records readings at a preset real time. An alarm circuit has a variable pitch for indicating the time for taking the temperature. Lights and words can indicate the user's status. The device is distinguishable for requiring only temperature data and sound responses.

U.S. Pat. No. 4,261,049 issued on Apr. 7, 1981, to Katsuhiko Komiyama et al. describes a wristwatch with solar cells and a battery displaying the time, day and month. The disclosure of the Komiyana patent is hereby incorporated by reference. The device is distinguishable for being limited to a conventional wristwatch powered by solar cells and a battery.

U.S. Pat. No. 4,534,012 issued on Aug. 6, 1985, to Yukio Yokozawa describes a communication system consisting of a programmable (push buttons) wristwatch with a speech input and output or a handheld calculator, an interface and an external computer or data processing station. The wristwatch and the external station have each a central processing unit, a memory, a display device, and an input and output device. The wristwatch normally displays the day, date and time. The wristwatch device is distinguishable for being required to communicate with a data processing station.

U.S. Pat. No. 4,163,230 issued on Jul. 31, 1979, to Tsuyoshi Konii describes a wristwatch having a display of the month, day and date, and a keyboard for a calculator. The device is distinguishable for requiring a calculator.

U.K. Patent Application No. GB 2 143 345 A published on Feb. 6, 1985, for Philip Y. T. Lam describes a pulsemeter based on a wristwatch configuration with an expansion band, but with the face showing a scale based on pulse rate per minute with a single rotating hand. The device is distinguishable for being limited to timing a pulse rate.

None of the above inventions and patents, taken either singularly or in combination, is seen to describe the instant invention as claimed. Thus, a multi-function health indicating wristwatch solving the aforementioned problems is desired.

### SUMMARY OF THE INVENTION

The health watch is a wristwatch worn by an athlete or the like capable of measuring and displaying by digital readout the wearer's blood pressure reading, pulse reading, and body temperature. The watch can show the time of day and can be used as a stopwatch, is illuminated, records information, is capable of downloading information to an external computer, and has a printout. The watch is solar powered to beep when a monitoring function is complete, and to page when a caller wishes to communicate with the user.

Accordingly, it is a principal object of the invention to provide a health indicating wristwatch capable of multiple chronometer functions, is capable of measuring body characteristics, and is capable of wireless receiving functions.

It is another object of the invention to provide a wristwatch capable of reading the user's body temperature, pulse and blood pressure, and notifying the user of changes in these parameters.

It is a further object of the invention to provide a wristwatch capable of: illumination of the display; digitally indicating the elapsed time and time of day; information recording; printing out recorded data; and downloading data to an external computer.

Still another object of the invention is to provide a wristwatch which is solar powered and can receive pages.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a digital health and communication receiving watch according to the present invention.

FIG. 2 is a top plan view of the health watch showing blood pressure on the display.

FIG. 3 is a top plan view of the health watch showing the measured pulse of the user on the display.

FIG. 4 is a top plan view of the health watch showing body temperature on the display.

FIG. 5 is a top plan view of the health watch a display of the current time.

FIG. 6 is a top plan view of the health watch showing the watch during computer downloads or uploads.

FIG. 7 is a top plan view of the health watch showing the display during printing.

Similar reference characters denote corresponding features consistently throughout the attached drawings.

### DETAILED DESCRIPTION OF THE PREFERRED EMBODIMENTS

The present invention is directed to a multi-function wristwatch 10 which measures vital body functions, accepts paging, shows current time and elapsed time, and can download the data to an external computer or printout on an enclosed paper strip.

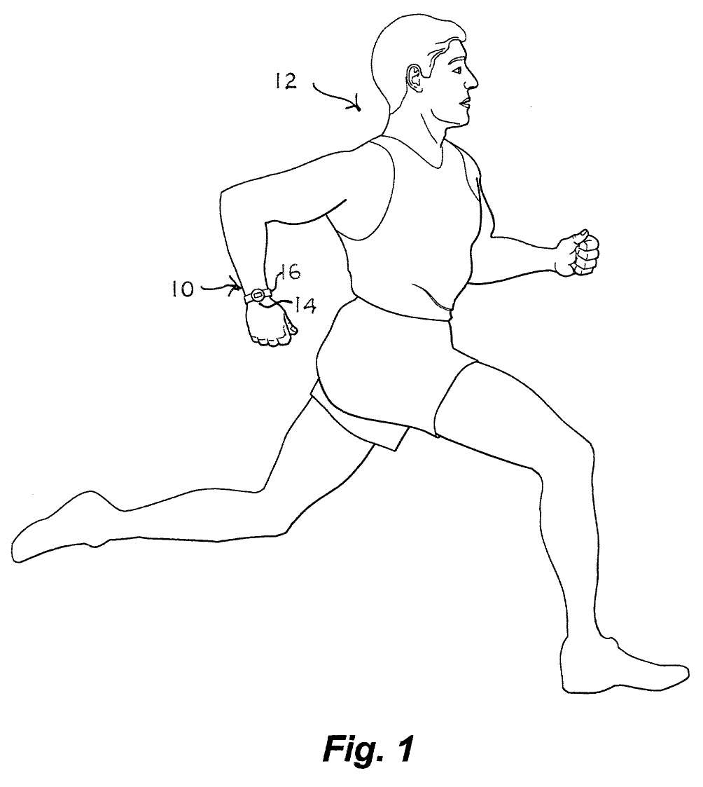

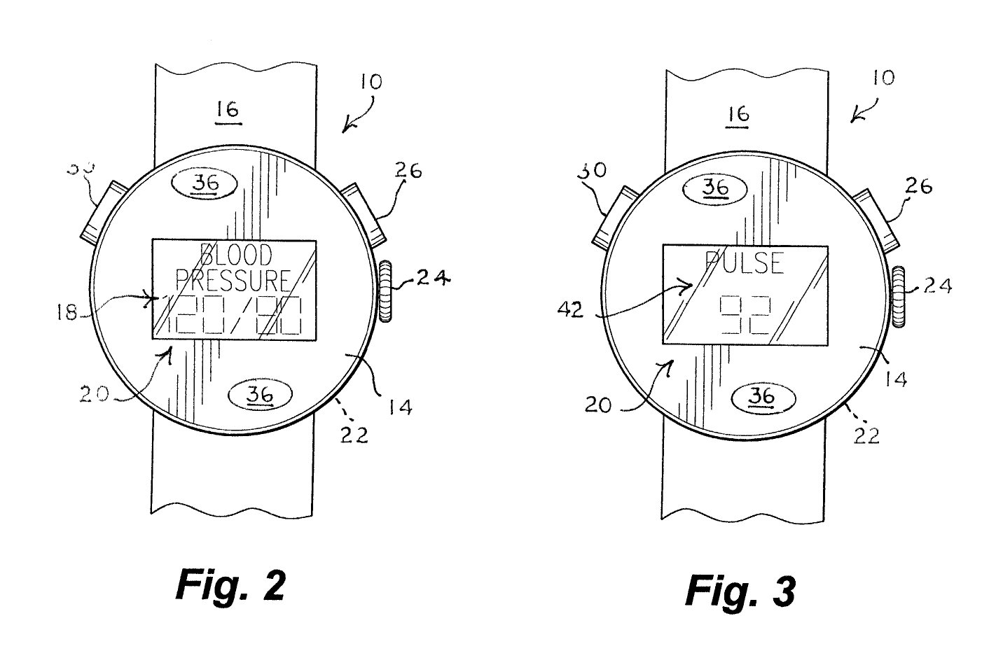

FIG. 1 illustrates a male athlete 12 running with a health indicating wristwatch 10 comprising a circular module 14 attached to a wrist band 16. FIG. 2 depicts the wristwatch 10 with the module 14 indicating instantaneous blood pressure indicia 18 and a reading of 120 over 80 which is a diastolic pressure of 120 mm Hg and a systolic pressure of 80 mm Hg in a liquid crystal display window or portion 20 disposed on a top surface of the module 10 which represents a normal diastolic pressure, but an above average systolic pressure. This blood pressure reading was obtained by a first push in of the push button 24. Sensors and circuitry for measuring blood pressure are described in the disclosure of U.S. Pat. Nos. 5,734,625 and 5,894,454, which have been incorporated by reference.

The module 14 is circular and flat in shape with three push buttons. A conventional circular access panel 22 (hidden) is located in the rear of the module 14. The knurled push button 24 is a program selection button located on the right side of the module 14 for determining which program is desired in a sequential fashion. Therefore, the first selection is the blood pressure. A printer tape outlet 26 is located adjacent to the program selection button 24. The enclosed computer printer 28 (hidden) is a miniaturized model of the type described in U.S. Pat. No. 4,525,075, previously incorporated by reference herein. On an opposite side of the printer tape outlet 26 is located the electronic connection 30 for unloading the data in the memory of a microprocessor controlled circuit or microcontroller disposed within the module to an external computer (not shown) at home.

A battery and current limiting circuitry is enclosed in the module 14 for energizing the microcontroller, the battery being recharged by solar cells 36 for energizing the microcontroller. Such an arrangement is disclosed in U.S. Pat. No. 4,261,049, previously incorporated by reference herein. A time keeping unit or electronic chronometer is also enclosed within the module 14. A plurality of sensing units are enclosed in or on the module 14 for measuring the wearer's body functions of body temperature, pulse and blood pressure.

FIG. 3 depicts the wristwatch 10 displaying the athlete's instantaneous pulse reading 42 as 92 beats per minute as the second selection in the program.

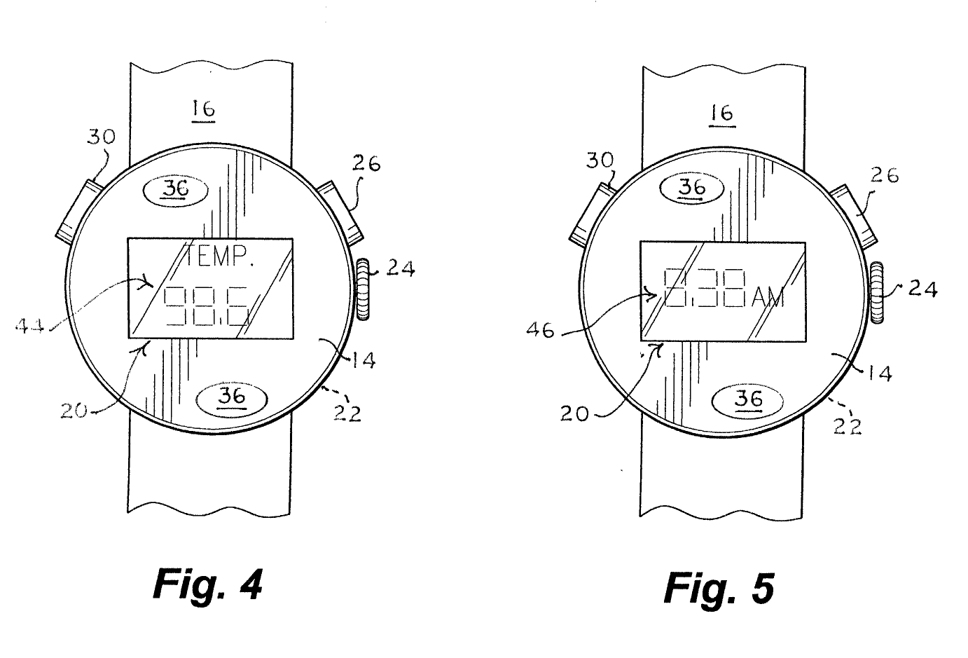

FIG. 4 shows the wristwatch 10 displaying the instantaneous body temperature 44 as 98.6° F. which is a normal body temperature, as the third selection in the program.

FIG. 5 depicts the wristwatch 10 displaying the current time of day 46 as 38 minutes after 8 A.M. as the fourth selection in the program. A fifth selection on the program is a stopwatch function of starting the stopwatch and a sixth push in to obtain the elapsed time.

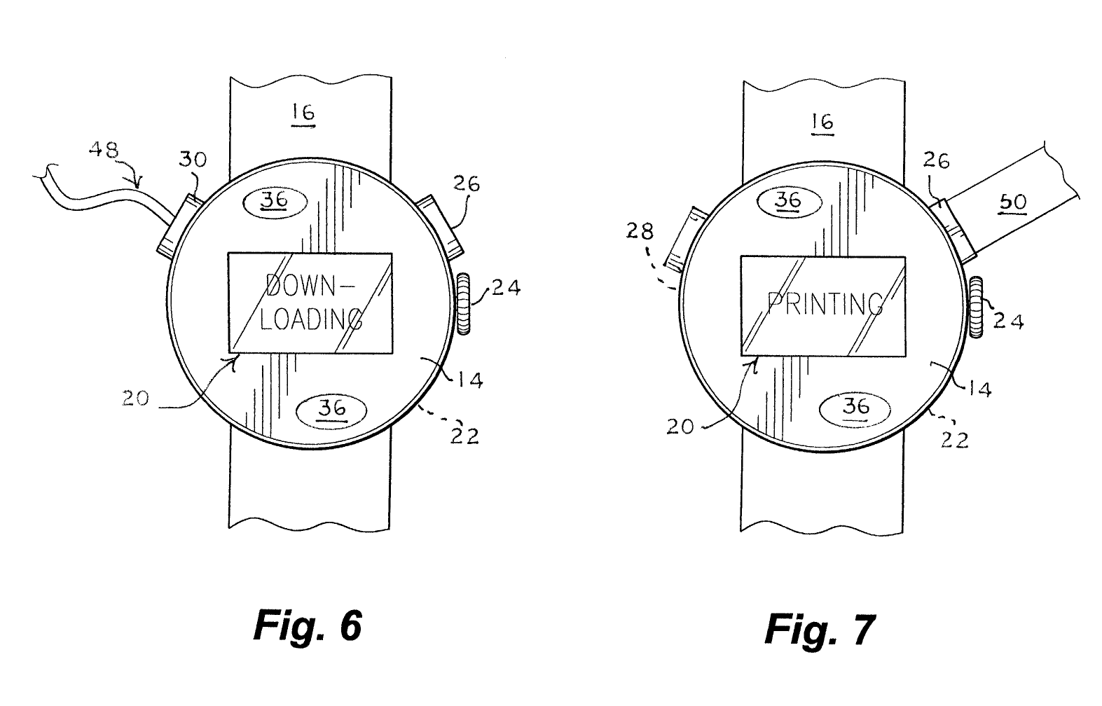

FIG. 6 illustrates the wristwatch 10 displaying a down loading message as the seventh selection, the information in the microcontroller being downloaded by connecting the plug and wire 48 to the external computer.

FIG. 7 shows the wristwatch 10 displaying the printing function with the printed tape 50 exiting the printer tape outlet 26 as the eighth selection in the program.

A ninth selection is the illumination of the liquid crystal display (LCD) window 20 by pushing in the push button 24. The push button 24 may be a two position momentary switch, with a shallow depression of the button 24 operating the above described functions and a deeper depression of the button 24 serving to illuminate the display. Alternatively, illumination of the display may be triggered by the length of time the button remains depressed. Both types of switches are well known in the art.

A tenth and final function that the wristwatch 10 has is a pager unit which digitizes the caller's telephone number in the LCD window 20 (not shown) or beeps by containing a random access memory and a piezoelectric element according to the incorporated disclosure of U.S. Pat. No. 5,848,027. The beeper unit 52 also is programmed to sound whenever a monitoring function (of body temperature, blood pressure or pulse) is complete. The wristwatch module 14 also contains an information recording means or memory in the microcontroller.

Thus, a multi-function health indicating wristwatch has been shown which has a display that can be illuminated, which serves as a beeper or pager, and which can measure and indicate the instantaneous blood pressure, pulse, body temperature, elapsed time (stopwatch function), the time of day, and perform the functions of downloading data to an external computer and printing out a tape with the information collected.

It is to be understood that the present invention is not limited to the embodiments described above, but encompasses any and all embodiments within the scope of the following claims.

We claim:

1. A health indicating wristwatch comprising:
a module housing having a wristband and capable of being worn on a wrist;
a liquid crystal display portion disposed on a top surface of the module housing for exhibiting a digital readout;
a microcontroller enclosed in the module;
a solar cell charging circuit and rechargeable battery enclosed in the module connected to solar cells mounted on the module housing and exposed to light for energizing the microcontroller;
a chronometer enclosed in the module;
sensing means enclosed in and on the module for measuring the wearer's body functions of body temperature, pulse and blood pressure; and
a push-in program activating knob located on a side of the module for selecting a function for display on the liquid crystal display.

2. The health indicating wristwatch according to claim 1, further comprising an illumination unit disposed in the module for illuminating the liquid display portion.

3. The health indicating wristwatch according to claim 1, further comprising a beeper unit disposed in the module for indicating when a monitoring function is complete.

4. The health indicating wristwatch according to claim 1, further comprising a pager unit disposed in the module.

5. The health indicating wristwatch according to claim 4, wherein the pager unit digitizes the caller's telephone number.

6. The health indicating wristwatch according to claim 1, further comprising an information recording means for recording information disposed in the module.

7. The health indicating wristwatch according to claim 1, further comprising a downloading terminal mounted in the module housing.

8. The health indicating wristwatch according to claim 7, wherein the downloading terminal is adapted for downloading to an external computer.

9. The health indicating wristwatch according to claim 1, further comprising a printer disposed in the module housing.

10. The health indicating wristwatch according to claim 9, wherein the printer is capable of printing out information on a tape and feeding the tape outside the module.
